(19) United States
(12) Patent Application Publication
(10) Pub. No.: US 2024/0262099 A1
(43) Pub. Date: Aug. 8, 2024

(54) INTERCHANGEABLE/MODULAR TEXTILE PRINTING POD SYSTEM

(71) Applicant: REGINALD PAUL KENNEDY, TUCSON, AZ (US)

(72) Inventor: REGINALD PAUL KENNEDY, TUCSON, AZ (US)

(21) Appl. No.: 18/430,245

(22) Filed: Feb. 1, 2024

Related U.S. Application Data
(60) Provisional application No. 63/482,946, filed on Feb. 2, 2023.

(51) Int. Cl. B41F 27/00; B41F 1/04; B41F 15/26; B41F 17/00

(52) U.S. Cl. CPC B41F 27/005; B41F 1/04; B41F 15/26; B41F 17/005; B41P 2215/112; B41P 2215/50

(57) ABSTRACT

The ‘Interchangeable/Modular Textile Printing Pod’ system marks a significant innovation in screen printing, merging manual techniques with textile enhancement in a singular, efficient design. It features a linear, expandable layout of printing Pods that optimize workspace by aligning along the perimeter, freeing central areas for broader use. Each Pod, equipped with versatile stations, connects via a Rail & Trolley mechanism, supporting seamless movement of heating attachments like Flash Heaters and Heat Presses across Pods. This design not only conserves space but also enhances workflow, enabling swift transitions across printing tasks. Ideal for space-constrained environments, this adaptable and scalable system offers a modern solution to diverse screen printing needs, embodying efficiency and flexibility in printmaking technology.

### FIELD OF INVENTION

“Hybrid Printmaking Technology,” specifically focusing on the integration of screen printing and heat press methodologies.

### BACKGROUND OF THE INVENTION

Screen printing and heat press applications have long stood as distinct pillars in the world of printmaking, each with its unique methodologies, applications, and limitations. Traditionally, these two processes have been viewed as separate entities, often necessitating different machinery and operational setups.

Screen printing, an ancient art form, involves pushing ink through a mesh screen to create images on various substrates. Its versatility in terms of inks, materials, and applications has made it a preferred method for high-volume production, particularly for apparel and posters. However, the process is often complex, requiring meticulous setup for multi-color designs, and is space-intensive due to the bulky nature of screen printing presses. Traditional screen printing machines are characterized by their central rotating arm structure, to which multiple screens or stations are attached. Despite their widespread use, these traditional machines present several limitations. First, the radial layout of rotary presses demands a substantial amount of floor space, which poses a challenge in smaller workshops or studios where space is limited. The physical structure of these machines inherently restricts the number of stations, and by extension, the number of colors that can be used in a design. To accommodate more colors, one typically has to invest in larger, more expensive equipment.

On the other hand, heat press applications, predominantly used for transferring designs onto fabrics, operate on a different principle. A design is first printed (often on special transfer paper) and then applied to the substrate using heat and pressure. This process is ideal for detailed, color-rich designs and smaller production runs. The limitations lie in its scope-primarily confined to flat surface applications-and the inability to efficiently handle large-volume orders.

Historically, these two methods have been viewed as opposing due to their differing equipment and process requirements. Screen printing setups lacked the capability for heat pressing, while heat press machines were not equipped for screen printing tasks. This dichotomy led to a divide in print shops, where businesses often had to choose between specializing in one method over the other or incurring significant costs and space to accommodate both.

The advent of new technologies and innovative machine designs is now challenging this traditional separation. Advances have led to the development of systems that integrate both screen printing and heat press functionalities into a single, more compact setup. This integration not only saves space and cost but also opens up a new realm of creative possibilities, allowing print shops to seamlessly transition between screen printing and heat press applications within the same workflow. This evolution marks a significant shift in the printmaking industry, bridging the gap between two historically distinct processes and paving the way for more versatile, efficient production methods.

### SUMMARY OF INVENTION

The present invention, termed “INTERCHANGEABLE/MODULAR TEXTILE PRINTING POD SYSTEM,” is an embodiment of a modular in-line expansion Pod system for manual textile printing (“apparatus” or “Pod” or “Pod apparatus”). This invention introduces a novel embodiment of two textile printing processes, manual screen printing and heat press applications. The modular composition is facilitated by the “Rail & Trolley mechanism”* and an “advanced Registration system”**, thereby providing enhanced efficiency, precision, and scalability in the textile printing process. It is characterized by its compact footprint and versatile layout options, offering significant space-saving advantages over traditional rotary presses. It is both a process and a machine designed to embody the process.

*This mechanism includes a Rail that allows the Trolley to move seamlessly through multiple “Pods,” carrying modular attachments used for a variation of printing applications.

**Refers to the process of aligning the colors of a design for printing. Within this system, for example, a single operator, or multiple operators, can screen print textiles using removable components that allow for simple alignment (“registration”) and “memorization” for future printing.

### BRIEF DESCRIPTION OF DRAWINGS

The embodiments herein may be better understood by referring to the following description in conjunction with the accompanying drawings in which like reference numerals indicate identically or functionally similar elements, of which:

FIG. 1 is a perspective view of a Pod apparatus for in-line modular expansion, manual screen printing and heat press application textiles printing. This embodiment includes all modular attachments; Print Stations, Quick Link Cart (Pod Cart or Cart), Trolley and Flash Heater attachment;

FIG. 2 is a side view of a Pod apparatus for in-line modular expansion, manual screen printing and heat press application textile printing. This embodiment includes all modular attachments; Print Stations, Quick Link Cart (Pod Cart or Cart), Trolley and Flash Heater attachment;

FIG. 3 is a top view of a Pod apparatus for in-line modular expansion, manual screen printing and heat press application textile printing. This embodiment includes all modular attachments; Print Stations, Quick Link Cart (Pod Cart or Cart), Trolley and Flash Heater attachment;

FIG. 4 is a perspective view of a Pod apparatus for in-line modular expansion, manual screen printing and heat press application textile printing. This embodiment isolates the Pod without any modular attachments;

FIG. 5 is a top view of a Pod apparatus for in-line modular expansion, manual screen printing and heat press application textile printing. This embodiment isolates the Pod without any modular attachments;

FIG. 6 is a side view of a Pod apparatus for in-line modular expansion, manual screen printing and heat press application textile printing, This embodiment isolates the Pod without any modular attachments;

FIG. 7 is an embodiment of the bottom view, perspective view and top view of the modular attachment, Print Station (platen), of a Pod apparatus for in-line modular expansion, manual screen printing and heat press application textile printing;

FIG. 8 is the front and side view of the Pod apparatus for in-line modular expansion, manual screen printing and heat press application textile printing, including the modular Print Station attachments;

FIG. 9 is the top view of the Pod apparatus for in-line modular expansion, manual screen printing and heat press application textile printing, including the modular Print Station attachments;

FIG. 10 is a perspective view and zoomed view of 2 Pod apparatus', joining together creating an in-line modular expansion for manual screen printing and heat press application textile printing;

FIG. 11 is the front view of an embodiment of the Trolley apparatus isolated from the Rail link system of a Pod apparatus for an in-line modular expansion, manual screen printing and heat press application textile printing;

FIG. 12 is a perspective view of an embodiment of the Trolley apparatus in conjunction with the Rail link system of a Pod apparatus for an in-line modular expansion, manual screen printing and heat press application textile printing;

FIG. 13 is a side view example of the modular Flash Heater attachment apparatus being removed from the Trolley apparatus, of a Pod apparatus, for in-line modular expansion;

FIG. 14 is a side view and perspective view of the Heat Press modular attachment, for an in-line modular expansion, manual screen printing and heat press application textile printing;

FIG. 15 is the top view and perspective views of the Quick Link Cart (Pod Cart or Cart) modular attachment for in-line expansion of manual screen printing and heat press application textile printing;

FIG. 16 is a perspective view of a Pod apparatus in communication with the modular Quick Link Cart (Pod Cart or Cart), for in-line expansion of manual screen printing and heat press application textile printing;

FIG. 17 is a perspective view of a Pod apparatus in communication with the modular Quick Link Cart (Pod Cart or Cart), including the modular Print Station attachments, for in-line expansion of manual screen printing and heat press application textile printing;

FIG. 18 is a perspective view and zoomed view, of an example connection between two modular Pod apparatus' linking together via Quick Link Cart (Pod Cart or Cart), of a Pod apparatus for in-line modular expansion, manual screen printing and heat press application textile printing;

FIG. 19 is an embodiment of the perspective view of the protruding side of the Quick Link Cart (Pod Cart or Cart) connection apparatus, for in-line expansion of manual screen printing and heat press application textile printing;

FIG. 20 is an embodiment of the perspective view of the recessed, receiving side of the modular Quick Link Cart (Pod Cart or Cart) connection apparatus, for in-line expansion of manual screen printing and heat press application textile printing;

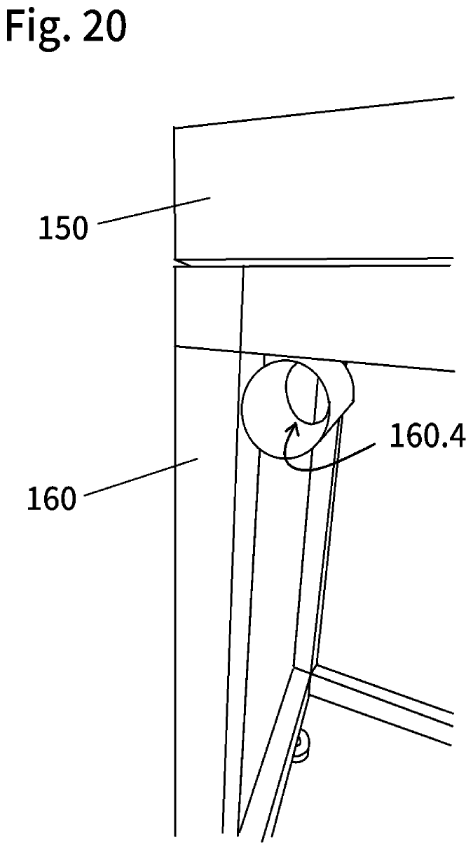

FIG. 21 is top view, side view and example of Registration Bracket attachments, used to temporarily attach the screen to the Pod apparatus for in-line modular expansion, manual screen printing and heat press application textile printing;

FIG. 22 is a perspective view and zoomed view of an example of an operator engaging the Registration Brackets (or Bracket) in communication with Registration Eyelets during the printing process on a Pod apparatus for in-line modular expansion, manual screen printing and heat press application textile printing;

FIGS. 23A-D are perspective views of the sequential screen printing process using the modular Pod apparatus in conjunction with the Registration system and Flash Heater modular attachments, for in-line expansion, manual screen printing and heat press application textile printing;

FIGS. 24A-D are perspective views of the sequential heat press process using the modular Pod apparatus in conjunction with the Heat Press attachment, for in-line expansion, manual screen printing and heat press application textile printing;

### DETAILED DESCRIPTION OF THE INVENTION

This section includes (1) elements of the apparatus (machine); (2) configurations; (3) interactions of elements (process) and process benefits.

### 1. Elements/Components of the Apparatus; Position of the Elements/Components (Machine)

This in-line INTERCHANGEABLE/MODULAR TEXTILE PRINTING POD SYSTEM, a manual screen printing and heat press invention, constitutes a paradigmatic advancement, ameliorating the constraints inherent in traditional manual screen printing presses. The process and apparatus' described herein alleviate the concerns mentioned above by introducing an interchangeable/modular, manual screen printing and heat press application textile printing system.

There are two primary parts of the invention apparatus: (a) the interchangeable modular expansion Pod(s); (b) the modular attachments.

a. Interchangeable Modular Expansion Pod (Pod)

The Pod is made up of three static components that are permanently affixed in a single location:

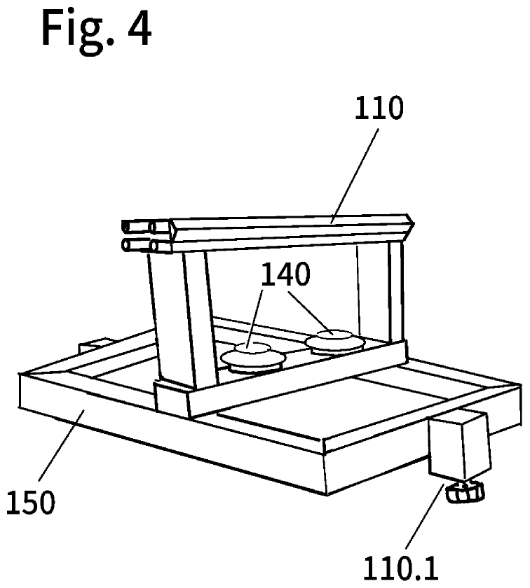

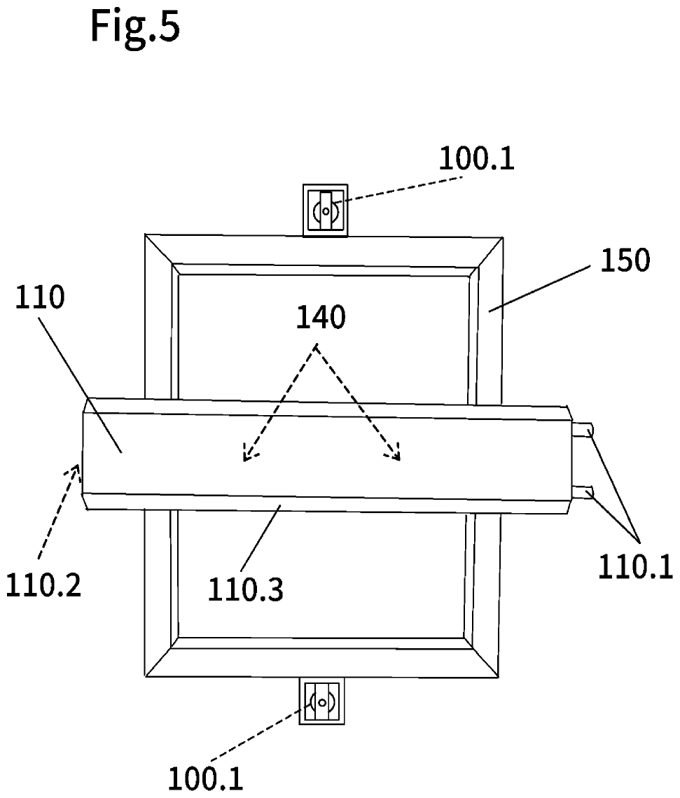

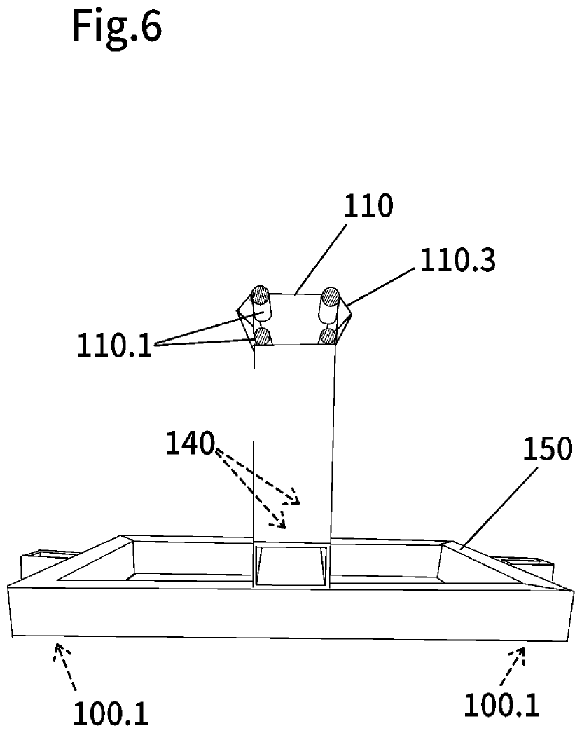

the Pod base FIGS. 4-6, (150);

the Registration Eyelets FIGS. 4-6, (140); and

the Rail FIGS. 4-6, (110).

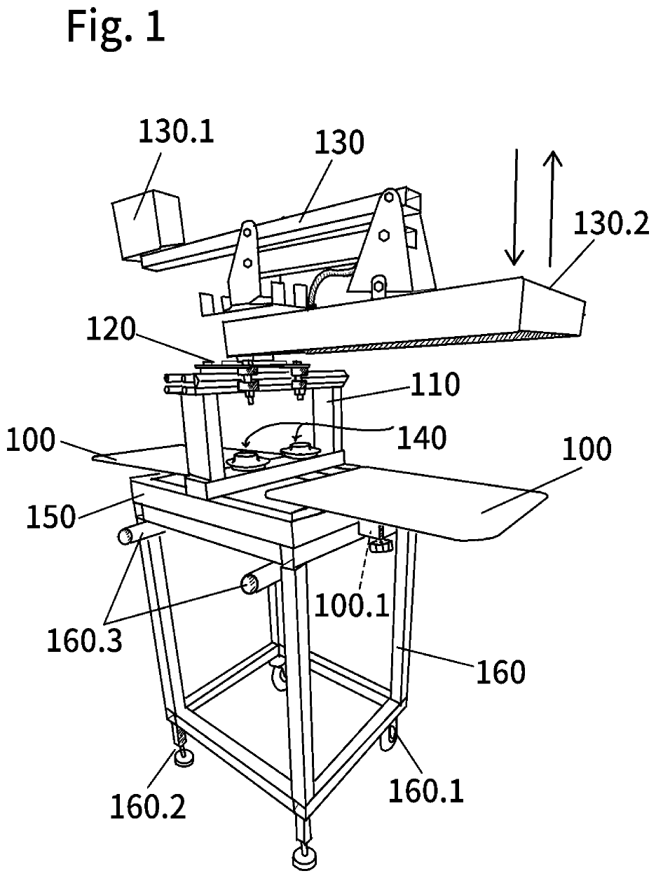

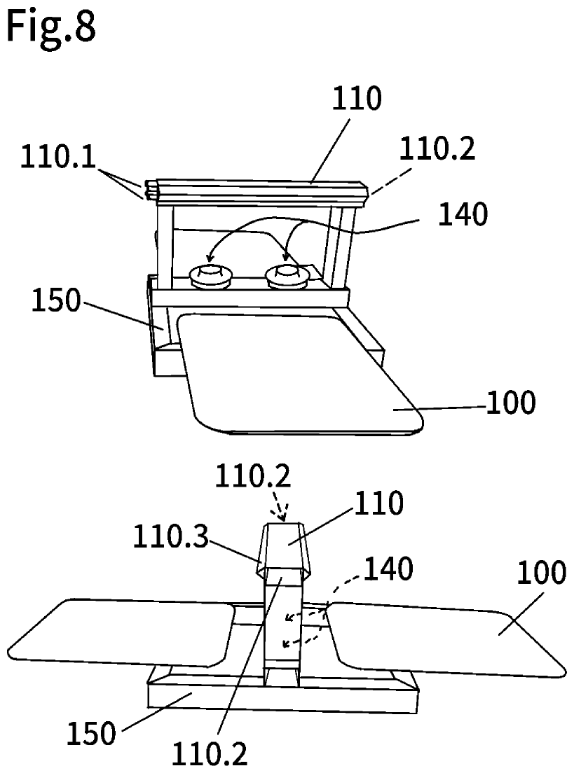

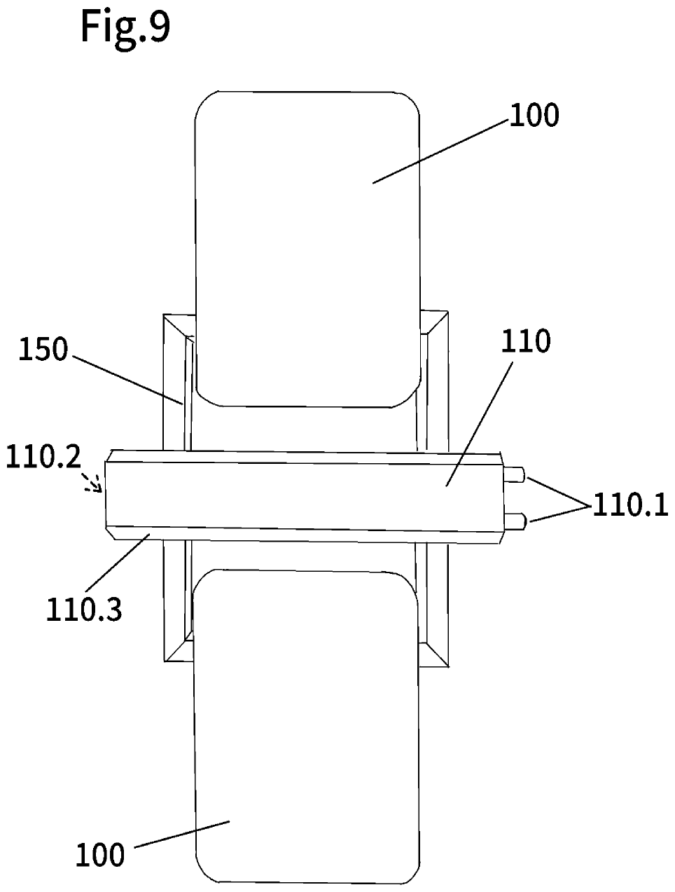

The Pod Base is the foundation of the Pod apparatus, made up of a square/rectangular base and the receiving ends of the Print Stations, which are square tubings, positioned on two opposite sides of the base, with a knob underneath FIGS. 1, 4-6, (100.1). The Registration Eyelets include a rectangular base and two eyelets affixed on top of the base. The Registration Eyelets are positioned above the Pod base but below the elevated Rail FIGS. 1, 4-6, 8, 10 & 12 (140). An elevated Rail is positioned above and is affixed to each Pod, FIGS. 1, 4-6, 8-10 & 12 (110).

b. Modular Attachments (Print Stations; Trolley; Flash Heater; Heat Press; Quick Link Cart; Registration Brackets)

The modular nature of these Pods allows for a plurality of configurations, contributing to the system's space-efficiency while enabling unlimited expansion of Print Stations. Various modular attachments are available within the system, including but not limited to: Print Stations; Trolley; Flash Heater; Heat Press; Quick Link Cart; Registration Brackets. All modular attachments and configurations are achieved without the use of tools.

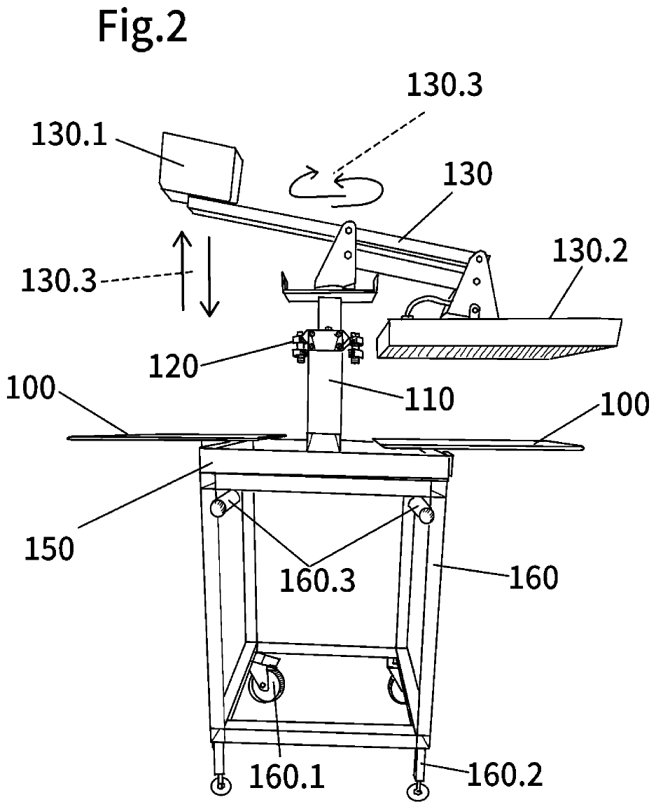

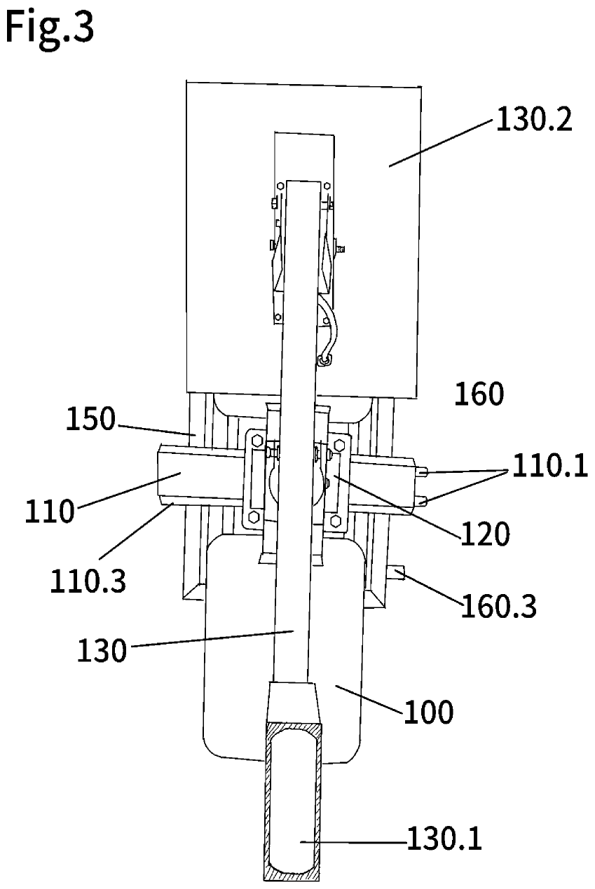

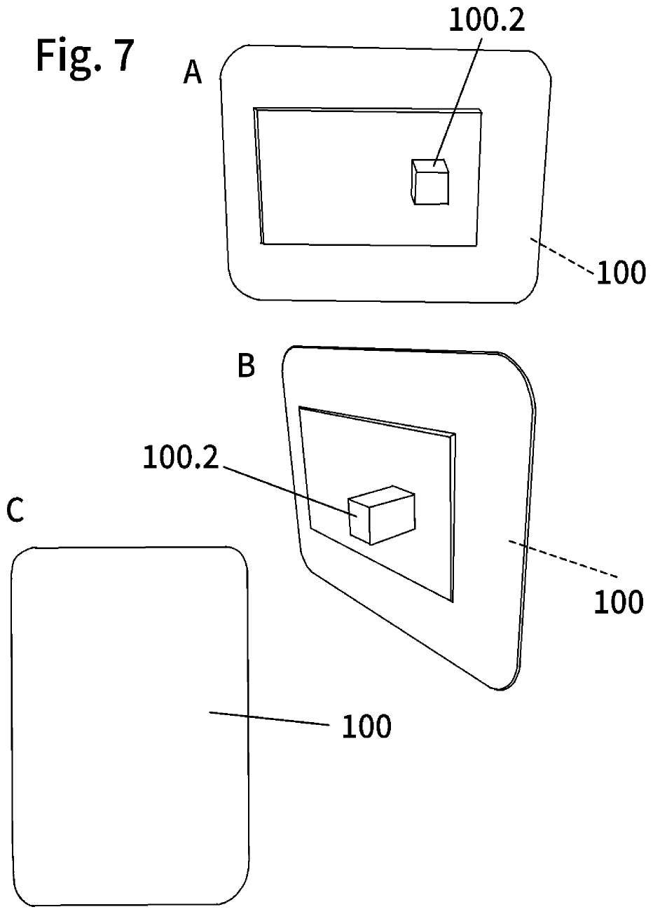

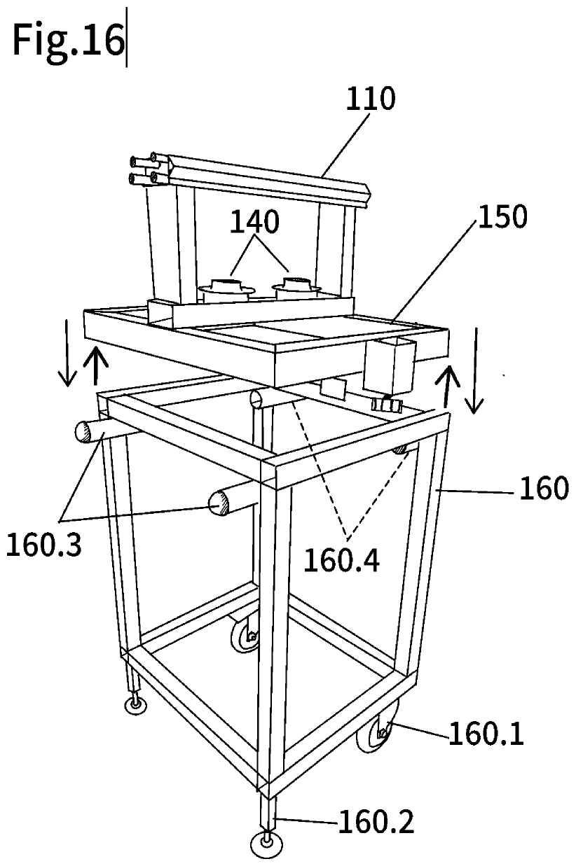

Print Stations: In reference to FIGS. 1-3 & 8-10 each pod (150) constituting an embodiment of the invention, includes one or two Printing Stations situated across from and opposite each other (100). Each Print Station has two components as shown in FIG. 7 (a “platen” (100) and “protruding Stem” (100.2). Each Print Station can be adjusted by separate height adjustments that raise or lower the distance between the screen and the Printing Station, as shown in FIG. 1 (this component is known as an “off contact” adjustment (100.1). The modular nature of these Pods allows for a plurality of configurations, contributing to the system's space-efficiency while enabling unlimited expansion of Print Stations. The Pod apparatus can be a standalone printing unit or housed within the Pods' Cart (Quick Link Cart). FIG. 16 demonstrates the removal of Pod from the Pod Cart. FIGS. 4-6 are examples and views of the Pod without the Cart and it's identifying printing and linking elements within a particular embodiment. The modular Print Station embodiment can be removed from Pod apparatus, and/or adjusted in height. FIG. 7, simplifies the components into two elements. The top (100) wherein the textile substrate is position for printing, is called the Print Station. Below is a mounted protrusion, on a plate which embodies a Stem (100.2), bonded by either weld or permanent adhesion.

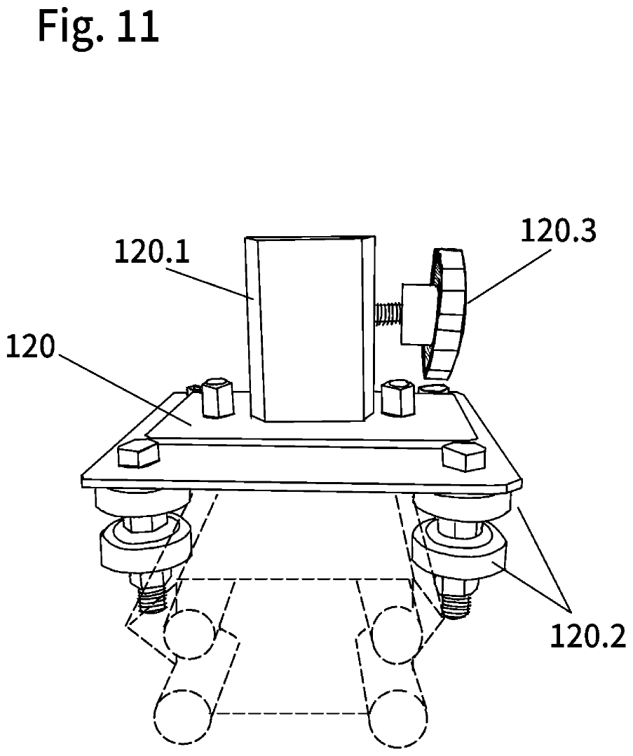

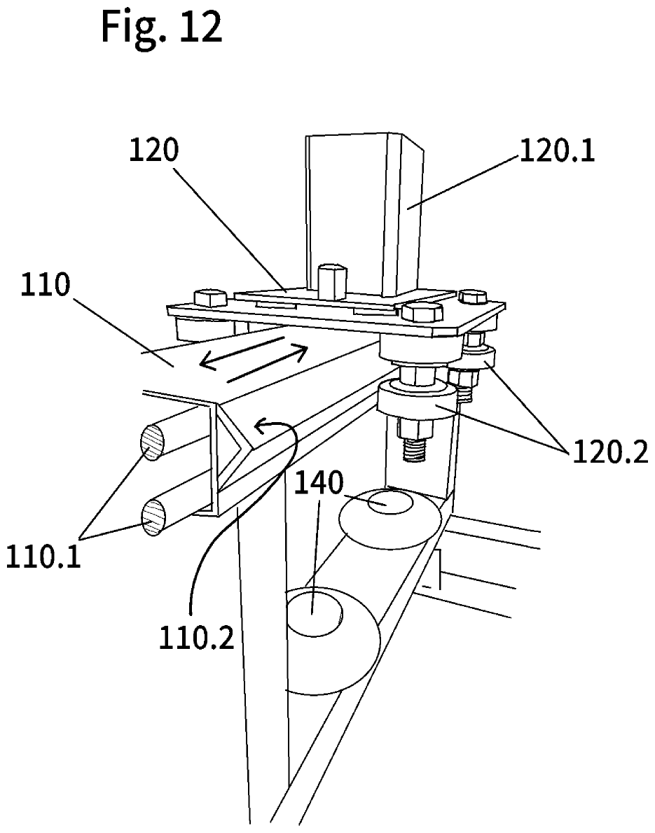

Trolley: Positioned above and in communication with each Pod, an elevated Rail (110) supports a Trolley (120). This Trolley is adapted to carry various modular attachments, thereby augmenting the functionality of the press. As shown in FIGS. 4-6, 8 & 9, The Pod apparatus' linking system resides in the Railing (110.1). Four small cylinder tubes, extrude from one side of the Rail, creating a linkage system wherein communication and conjunction with another Pod's opposite end, to exhibit a modular, in-line expansion (110.2). FIG. 12 shows the embodiment of this apparatus, referred to as Trolley (120), that glides back in forth along the Pod's Railing system (110). The Trolley (120), and its elements, are pivotal to the functionality of the overall system, carrying modular attachments from one Pod to another. FIG. 11 breaks down the components of the Trolley. The entirety of the Trolley achieves mobility through the use of bearings or wheels (120.2) that are kept on track by a vortex extrusion that prevents it's derailing or detachment FIG. 12 (110.3). The receiving Stem (120.1), enables a variety of modular attachments to be secured in communication with the Trolley, held in place by a studded knob, tightened by hand, FIG. 11. (120.3).

Flash Heater and Heat Press Modular Attachments: Each of these interchangeable attachments, affixed to the Trolley, is characterized by a 360-degree range of motion along with vertical (up and down) maneuverability (130.3), as demonstrated in FIGS. 1, 2, 13 & 14. This functionality facilitates comprehensive coverage and ease of operation over the printed substrate.

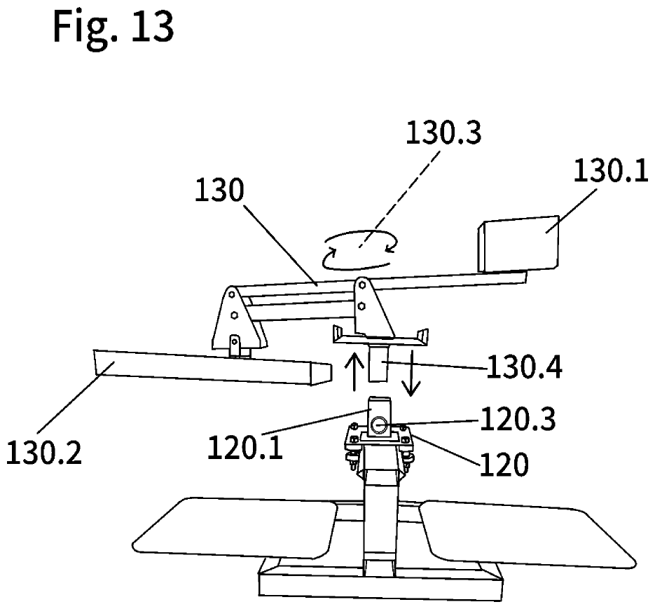

Flash Heater Modular Attachment: FIG. 13 (130) Configured for ‘print-flash-print’ operations or ‘curing’, this attachment facilitates the rapid drying of inks on printed garments or textile substrates by hovering over the substrate, when manually screen printing.

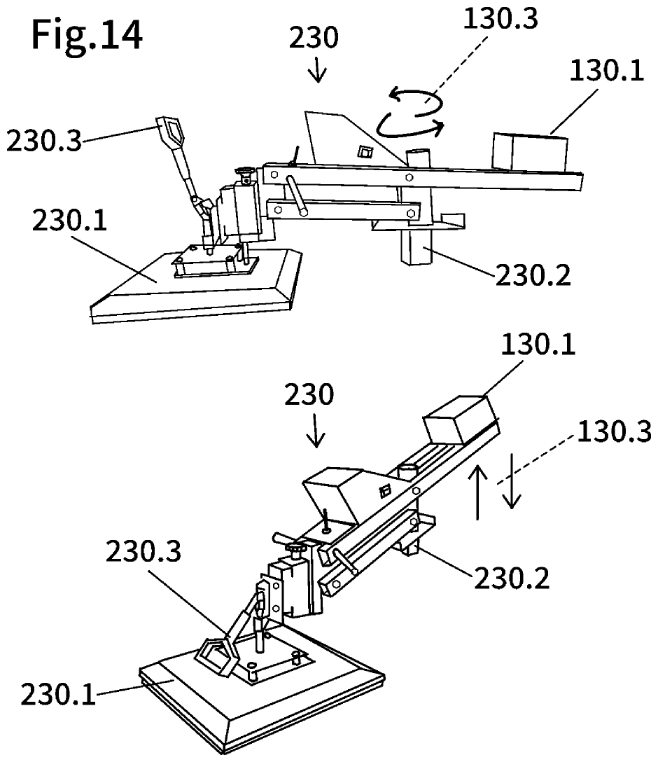

Heat Press Modular Attachment: (FIG. 14) This component is designed to transfer heat-sensitive materials, including vinyls and DTFs (direct to film), onto the substrate through applied pressure and heat directly onto the substrate, during heat press printing.

These modular Trolley attachment apparatus' are further enhanced by a counterbalance system (130.1), positioned opposite the heating elements (130.2 & 230.1) as shown in FIGS. 13 & 14. This counterbalance is designed to provide ease of motion, enabling the operator to maneuver the attachment with minimal effort. The incorporation of this counterbalance system within the attachment exemplifies an embodiment of the invention wherein operational efficiency and user ergonomics are significantly improved. FIG. 13 is an example motion of removing the Flash Heater attachment (130) from the Trolley (120) by lifting, separating the Flash Heater protrusion Stem (130.4) from the receiving Trolley Stem (120.1). The Heat Press or other modular attachments can then be substituted.

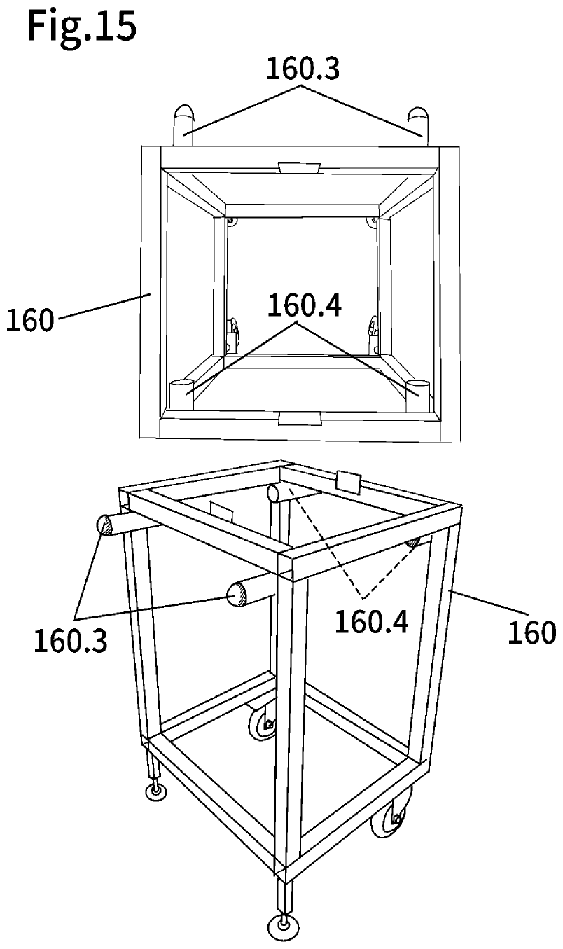

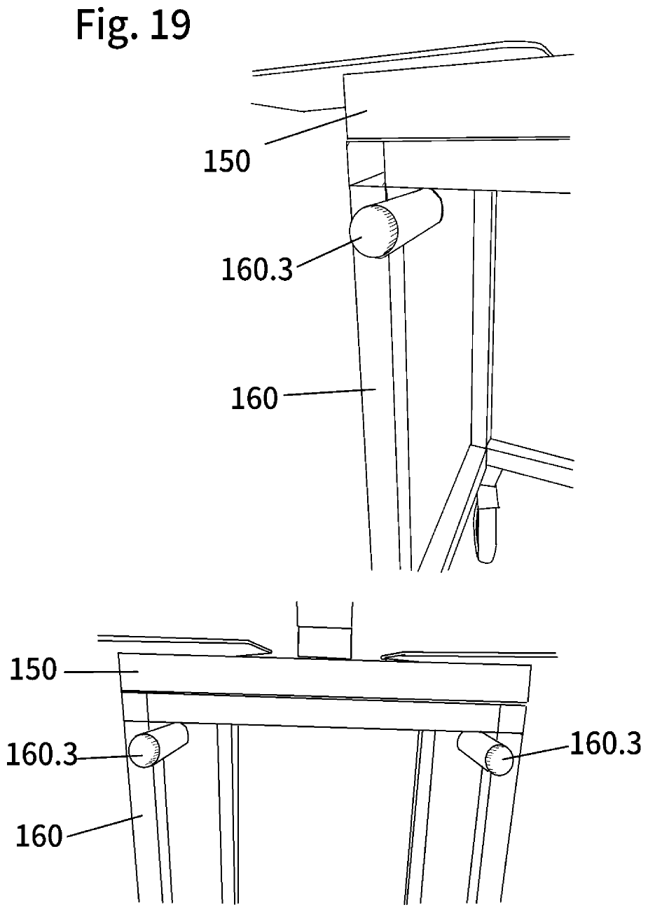

Quick Link Cart (Pod Cart or Cart): The Pod apparatus can be a standalone printing unit or housed within the Pods' Quick Link Cart. FIG. 16 demonstrates the removal of Pod from the Pod Cart. FIG. 15, is a top view and perspective view of the Cart without the Pod. FIGS. 19 & 20 are perspective views of Cart's identifying linking elements within a particular embodiment. This Cart can also be used for storage of supplies: inks, adhesive sprays, tape and other printing supplies.

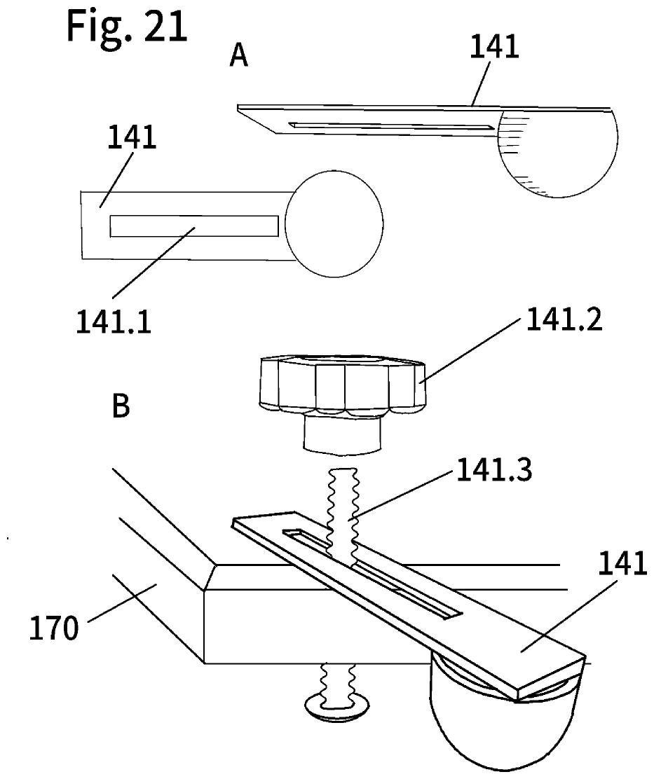

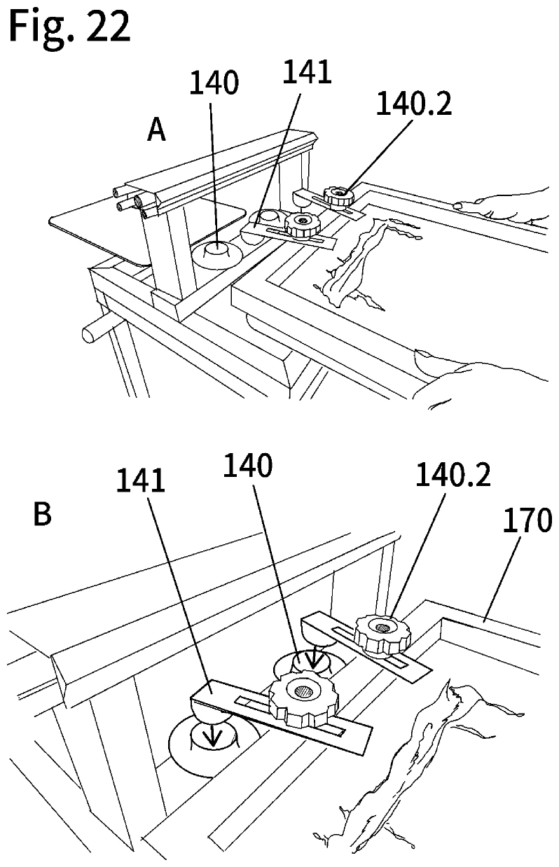

Advanced Registration System: The press employs Registration Eyelets (140) positioned below the rail, in communication with Registration Brackets FIGS. 21-23, (141) attached to a screen (170). This system enables precise alignment and registration of designs onto the print stations transferring to the textile, thereby simplifying the printing process. Owing to the distinctive design wherein the screens are not affixed directly to the printing press, as is customary with conventional manual rotary presses, but are instead connected to the actual screens via Registration Brackets (FIG. 22). This system bestows upon operators the capability to engage in multiple-color projects without facing limitations or constraints typically imposed by traditional print head restrictions. This innovative approach significantly enhances the versatility and efficiency of the screen printing process, allowing for an expansive range of colors and simultaneous project executions without the traditional barriers encountered in screen printing setups.

### 2. Configuration

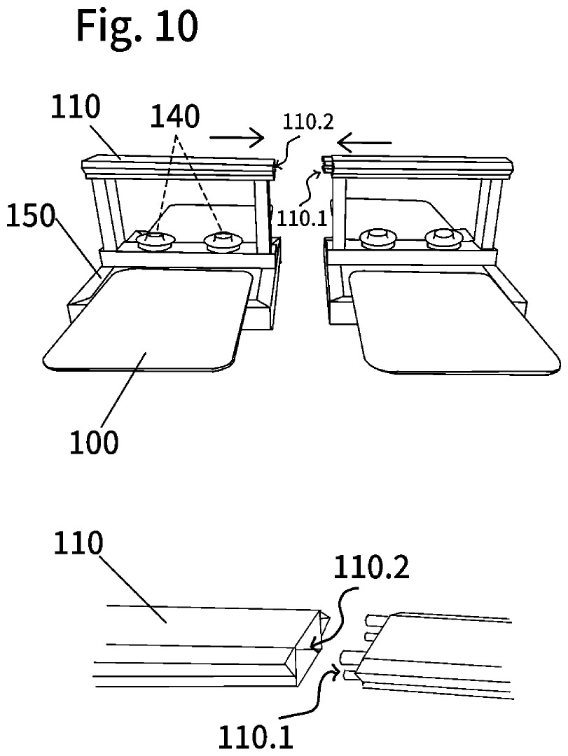

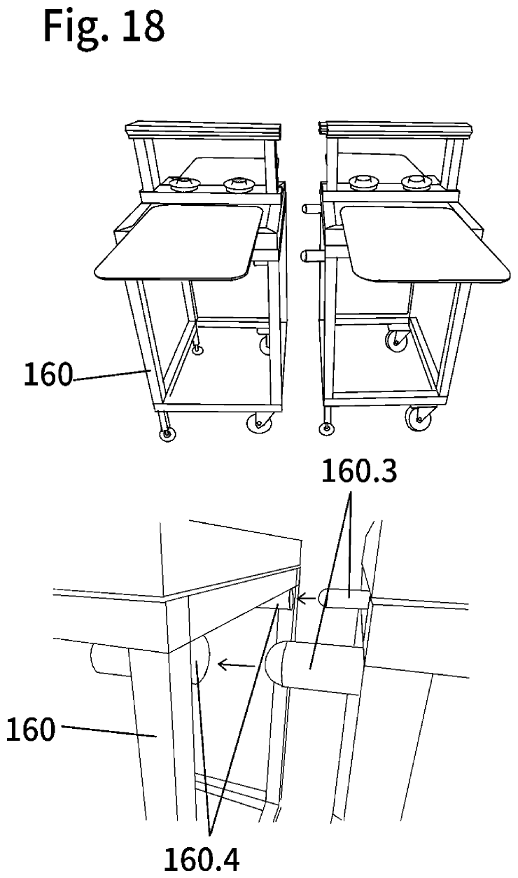

Configuration: Beginning with the setup of the Interchangeable/Modular Textile Printing Pod System, regardless of printing application (screen printing or heat press), operators first arrange the Pod apparatus in one of two printing configurations: (a) the modular Quick Link Cart which can be linked to other Quick Link Carts using their innovative protruding and recessed receiving connections (FIG. 18); or (b) the isolated Pod apparatus which can be placed on a table or other sturdy surface (FIG. 10).

a. Quick Link Cart Configuration

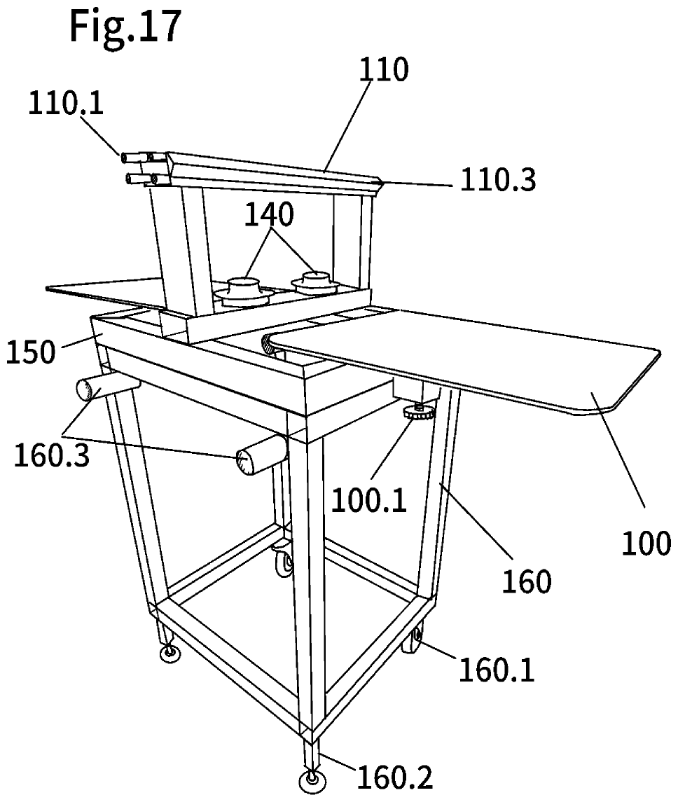

This configuration offers mobility and stability through caster wheels (160.1) and leveling feet (160.2) as shown In FIG. 17. FIG. 18, demonstrates the construction of the Cart, a critical feature is the incorporation of a unique linking mechanism. This mechanism consists of a protrusion (160.3) on one side of the Cart and a corresponding recessed receiving connection on the opposite end (FIG. 18, 160.4). When two Carts are positioned adjacent to each other, these opposite ends interact to form the ‘Quick Link modular system’, as exemplified in FIG. 18. This system facilitates a seamless and secure connection between plurality of Carts, enabling the effortless assembly and expansion of the screen printing setup. The design of the protrusion and recessed connection is engineered to ensure a stable and robust linkage, thereby reinforcing the operational efficiency and structural integrity of the combined Cart. This feature exemplifies the innovative approach of the invention in providing a scalable and adaptable solution to meet diverse printing requirements and workspace configurations. The leveling feet (160.2) assist in the alignment between plurality of Carts. The scaleability and expansion of plurality of Carts in conjunction with their respective Print Stations, can be replicated in an endless, continuous linear fashion. The connection process is manually implemented by the operator, with minimal effort by tilting the Cart on its caster wheels and joining the recessed linking component (160.4) into the extrusive linking component (160.3). Linking simultaneously takes place at the rail, between both Pods and Carts, forging a continuous connection for the Trolley to maneuver between Print Stations.

b. Isolated Pod Configuration

The isolated Pod configuration (FIG. 10) showcases exceptional versatility and adaptability to expand linearly on a table or other sturdy surfaces. Each Pod can be laid out and connected to adjacent ones, forming an integrated, linear printing line. This seamless connection is facilitated by specialized alignment brackets on the elevated Rail (110.1 & 110.2), which is affixed to each Pod. These brackets not only ensure precise alignment and stability when Pods are linked but also enable the Trolley, equipped with modular heating attachments, to maneuver effortlessly between Pods. This configuration creates an endless in-line array of Print Stations, allowing for uninterrupted and efficient printing operations. The ability of the Trolley to traverse across connected Pods without hindrance not only enhances the system's modular nature but also significantly reduces its spatial footprint, making it an ideal solution for various workspace environments while maintaining high efficiency and functionality in screen printing processes.

### 3. Printing Process'

a. Screen Printing

The printing configurations, above, form a cohesive and efficient workspace that can be customized to the desired number of Pods, ideally set up parallel to a wall or structure to optimize space. Screens, already prepared with photosensitive emulsion and exposed with the design, are equipped with Registration Brackets.

In FIG. 21, the Registration Brackets (141), integral to this system, are designed as rectangular entities featuring a central open slot (141.1) for adjustment purposes. Each Bracket is uniquely equipped with a half-ball structure at one end. This bracket is affixed to the screen through a methodical process: a bolt (141.3) is first inserted from the underside of the screen (170), then threaded through the bracket's slot (141.1), and finally secured in place with a knob (141.2). The strategic design of the cutout slot within the bracket facilitates precise adjustments during the alignment phase of design setups, prior to the initiation of printing operations. Once the design is accurately registered, the activation of the screen and registration system is achieved by the operator positioning the screen, with the Registration Brackets attached, into the Registration Eyelets (FIG. 22). This action secures the screen firmly in place, ensuring stability and precision during the printing process.

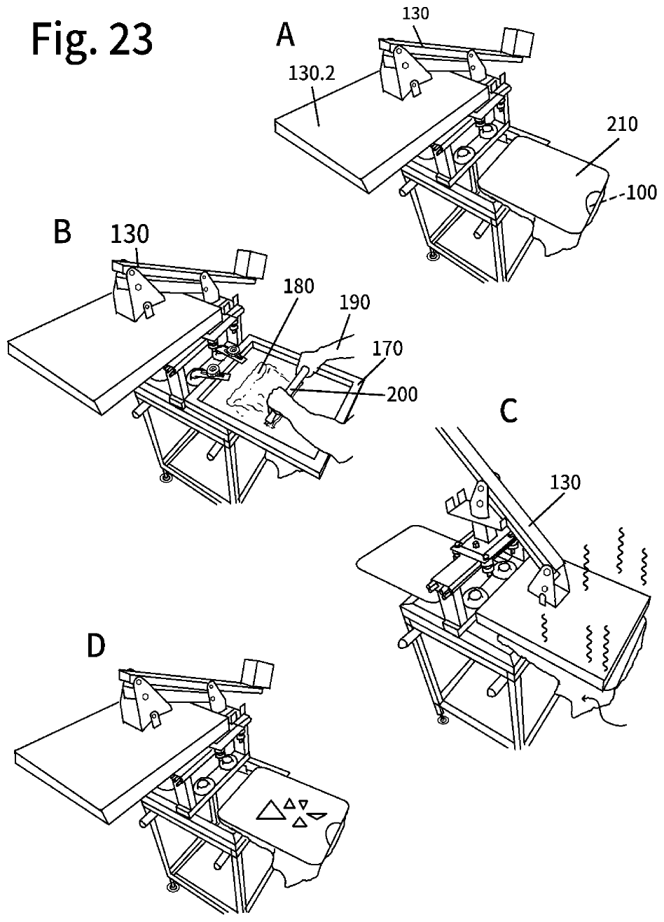

In FIGS. 23, A-D, (A)the printing process involves placement of substrate, in this example a shirt (210), onto Printing Station (100). (B) Applying ink (180) to the screen (170) and using a squeegee (200) to evenly spread and force the ink through the screen onto the substrate below (210). The operator carries the screen from one Pod and Print Station to another. For multi-color designs, the process is repeated with subsequent screens at different Pods, each pre-registered with a different color ink.

The system's modular attachments, such as the Trolley-mounted Flash Heater and/or Heat Press, add versatility to the printing process. As exemplified in FIG. 23-C, after each color application, the Flash Heater can be maneuvered over the substrate for rapid ink drying, allowing for immediate application of the next color. FIG. 23-D, shows the printing results after flashing applied color.

Finally, once the printing job is completed, the screens are cleaned and the modular Quick Link Carts or in-lined Pod configuration, can be detached and stored as needed, highlighting the system's space efficiency and ease of reconfiguration for future projects. This entire process underscores the ‘Interchangeable/Modular Screen Printing Pod System's capacity for high-quality, multi-color screen printing while maximizing operational efficiency and workspace utilization.

b. Heat Press

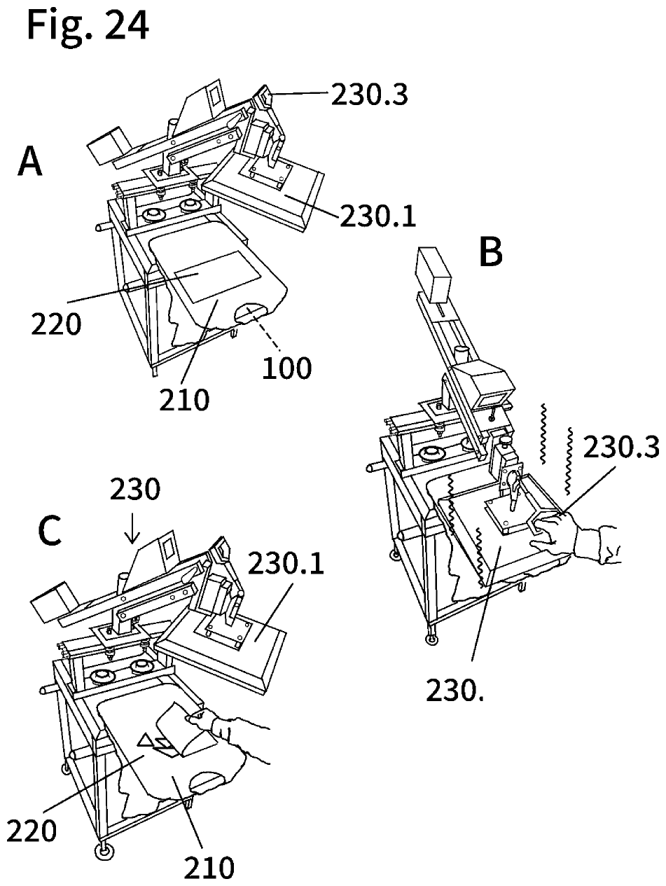

In FIGS. 24A-D, The Heat Press attachment in the modular screen printing system plays a crucial role in expanding the capabilities of the traditional screen printing process, particularly in applying heat transfer materials such as vinyl. Mounted on the Trolley for easy maneuverability, the Heat Press (230) can be accurately positioned over the substrate immediately following the screen printing and drying phases. (A) Here, a pre-cut and weeded vinyl (220) design is carefully placed on the substrate at the desired location. Once in position, (B) the Heat Press is lowered onto the substrate and vinyl manually by operator with provided handle (230.3). It then applies a precise combination of heat and pressure, a critical step where the heat activates the adhesive on the vinyl, ensuring a strong, durable bond with the substrate. (C) After the heat application, which varies in duration depending on the material, the Heat Press is lifted, and the substrate is allowed to cool. The final step involves peeling off the backing paper from the vinyl, leaving a cleanly applied design. This integration of the Heat Press into the workflow not only streamlines the process but also opens up a wider range of creative possibilities for screen printing projects.

c. Additional Process Benefits

The Interchangeable/Modular Textile Printing Pod System introduces a remarkable advancement in screen printing layout and operational design, focusing on maximizing the efficiency of workspace utilization while offering expansive scalability. A standout feature of this Pod system is its ability to create an ‘endless’ linear layout of Pods and Print Stations along the perimeter of a room or workspace. Central to this integration is the Trolley system, designed to traverse effortlessly across the unlimited arrangement of Pods. This mobility is a key factor in maintaining a smooth and efficient workflow, as it allows the Trolley, equipped with essential modular heating attachments like the Flash Heater and Heat Press, to move between Print Stations without any hindrance. The ease with which the Trolley transitions from one Pod to another in this linear setup ensures that operators can perform various printing and post-printing processes, such as ‘print-flash-print’ cycles and heat transfers, without the need to reposition or manually transfer substrates between stations.

This innovative layout design preserves the valuable interior space of the workshop or studio, a crucial advantage particularly in environments where floor space is at a premium. By aligning the Pods linearly against the walls, the Interchangeable/Modular Textile Printing Pod System ensures that the central area remains open and accessible. This not only facilitates easier movement within the workspace but also allows for the accommodation of additional equipment, storage, or work areas, thereby enhancing the overall functionality of the space.

Furthermore, the ability to expand the number of Pods and Print Stations linearly provides unparalleled flexibility in scaling up operations. Screen printing businesses can effortlessly add more Pods as their workload increases, without the need to reconfigure or significantly alter their existing workspace layout. This aspect of the invention is particularly beneficial for businesses that anticipate growth or experience fluctuating demands.

1. A modular Pod textile printing system comprising:
a series of unlimited expandable, interconnected modular Pods;
each Pod equipped with facilities for both screen printing and heat press applications;
an affixed Rail for modular seamless connections between Pods;
an integrated Rail and Trolley System for positioning various modular attachments specific to each printing technique.

2. A modular Pod Attachment system for a textile printing apparatus comprising:
a Trolley apparatus capable of transporting modular attachments across multiple Pods;
modular attachments including but not limited to Flash Heaters and Heat Presses;
attachment features facilitating swift transition between screen printing and heat press functions.

3. An Integrated Registration system within the textile printing apparatus, comprising:
of Registration Brackets designed for precise alignment in screen printing;
Registration Eyelets affixed to Pods securing Registration Brackets for screen printing;
memorization of design registration for use on multi-color printing and fluidity between simultaneous printing projects.

4. The Modular Pod Textile Printing System of claim 1, wherein the linear arrangement of Pods can be housed in a Cart to further versify flexibility of possible configurations.

5. The Modular Attachment System of claim 2, wherein the Trolley glides either by manual force or motorized propulsion.

6. The modular Pod textile printing system of claim 1, wherein the materials of the Pod, Rail and Trolley, and Registration system are comprised of steel and aluminum but not limited to high-strength composites and plastics.
